(19) United States
(12) Patent Application Publication
(10) Pub. No.: US 2016/0369958 A1
(43) Pub. Date: Dec. 22, 2016

(54) LIGHTING APPARATUS

(71) Applicant: One by One Co., Ltd., Osaka (JP)

(72) Inventor: Kuniharu KOHSHIMA, Osaka (JP)

(73) Assignee: One by One Co., Ltd., Osaka (JP)

(21) Appl. No.: 15/177,487

(22) Filed: Jun. 9, 2016

(30) Foreign Application Priority Data
Jun. 17, 2015 (JP) 2015-122097

(51) Int. Cl. F21S 4/28; F21V 19/00

(52) U.S. Cl. CPC F21S 4/28; F21V 19/008; F21V 19/003

(57) ABSTRACT

A lighting apparatus that enables a wide range to be irradiated and enables the light irradiation angle to be easily changed includes a fixation unit and a lighting unit attachable to and detachable from the fixation unit. The fixation unit includes: a first mounting portion having an arc surface having an arc-shaped cross section perpendicular to a longitudinal direction such that the arc shape is continuously formed along the longitudinal direction; and a fixation portion for fixing the first mounting portion. The lighting unit includes: a light source portion formed along the longitudinal direction; a holding portion holding the light source portion; and a second mounting portion provided along the longitudinal direction on the holding portion and having a mounting surface to be magnetically attached at any position in the circumferential direction on the arc surface of the first mounting portion. The second mounting portion is formed by a magnet.

### BACKGROUND OF THE INVENTION

### 1. Field of the Invention

The present invention relates to a lighting apparatus that enables a wide range to be irradiated with light and enables the light irradiation angle to be easily changed.

### 2. Description of the Background Art

A conventional lighting apparatus has a magnet provided to a columnar housing having a light source, and is used with the magnet magnetically attached to a metal wall surface (for example, see Japanese Laid-Open Patent Publication No. 2012-47765). Another conventional lighting apparatus has a housing and a magnet provided to the housing, and is magnetically attached to a metal wall surface (for example, see Japanese Utility Model Publication No. 3001842). Still another conventional lighting apparatus has a magnet provided to a columnar housing having a light source, and is magnetically attached to a metal bicycle component (for example, see a product “lucetta” dealt in by “palomar”, [online], [searched on Jun. 9, 2015], the Internet <URL; http://www.palomarweb.com/cms/content/lucetta>).

The conventional lighting apparatuses only irradiate a certain limited range, and therefore have a problem that it is difficult to irradiate a wide range with light and easily change the irradiation angle.

### SUMMARY OF THE INVENTION

The present invention has been made to solve the above problem, and an object of the present invention is to provide a lighting apparatus that enables a wide range to be irradiated with light and enables the light irradiation angle to be easily changed.

The lighting apparatus of the present invention is a lighting apparatus including: a fixation unit; and a lighting unit attachable to and detachable from the fixation unit. The fixation unit includes: a first mounting portion having an arc surface whose cross section perpendicular to a longitudinal direction has an arc shape, the arc shape being continuously formed along the longitudinal direction; and a fixation portion to which the first mounting portion is fixed. The lighting unit includes: a light source portion formed along the longitudinal direction; a holding portion holding the light source portion; and a second mounting portion provided along the longitudinal direction on the holding portion and having a mounting surface to be magnetically attached at any position in a circumferential direction on the arc surface of the first mounting portion. At least one of the first mounting portion and the second mounting portion is formed by a magnet.

The lighting apparatus of the present invention enables a wide range to be irradiated with light and enables the irradiation angle to be easily changed.

The foregoing and other objects, features, aspects and advantages of the present invention will become more apparent from the following detailed description when read in conjunction with the accompanying drawings.

### BRIEF DESCRIPTION OF THE DRAWINGS

FIG. 1 is a side sectional view showing the configuration of a lighting apparatus in the first embodiment of the present invention;

FIG. 2 is a side sectional view showing the configuration of a fixation unit of the lighting apparatus shown in FIG. 1;

FIG. 3 is a side sectional view showing the configuration of a lighting unit of the lighting apparatus shown in FIG. 1;

FIG. 4 is a perspective view showing the configuration of a the fixation unit of the lighting apparatus shown in FIG. 1;

FIG. 5 is a perspective view showing the configuration of the lighting unit of the lighting apparatus shown in FIG. 1;

FIGS. 6A and 6B are a top view and a bottom view showing the configuration of the lighting unit of the lighting apparatus shown in FIG. 1;

FIGS. 7A and 7B are perspective views showing the fixation unit and the lighting unit of the lighting apparatus shown in FIG. 1, when combined;

FIG. 8 is a side view showing movement of the lighting unit in the fixation unit of the lighting apparatus shown in FIG. 1;

FIG. 9 is a view showing locations where the lighting apparatus shown in FIG. 1 is installed;

FIG. 10 is a view showing a configuration for obtaining power, of the lighting apparatus shown in FIG. 1;

FIG. 11 is a view showing a configuration for obtaining power, of the lighting apparatus shown in FIG. 1;

FIG. 12 is a view showing a configuration for obtaining power, of the lighting apparatus shown in FIG. 1;

FIG. 13 is a view showing a configuration for obtaining power, of the lighting apparatus shown in FIG. 1;

FIG. 14 is a sectional view showing another configuration of the lighting unit of the lighting apparatus in the first embodiment of the present invention;

FIG. 15 is a sectional view showing another configuration of the lighting unit of the lighting apparatus in the first embodiment of the present invention;

FIGS. 16A and 16B are views showing the configuration of a fixation unit of a lighting apparatus in the second embodiment of the present invention;

FIG. 17 is a perspective view showing the configuration of the fixation unit of the lighting apparatus shown in FIG. 16; and

FIG. 18 is a view showing an installation example of the fixation unit of the lighting apparatus shown in FIG. 16.

### DETAILED DESCRIPTION OF THE PREFERRED EMBODIMENTS OF THE INVENTION

### First Embodiment

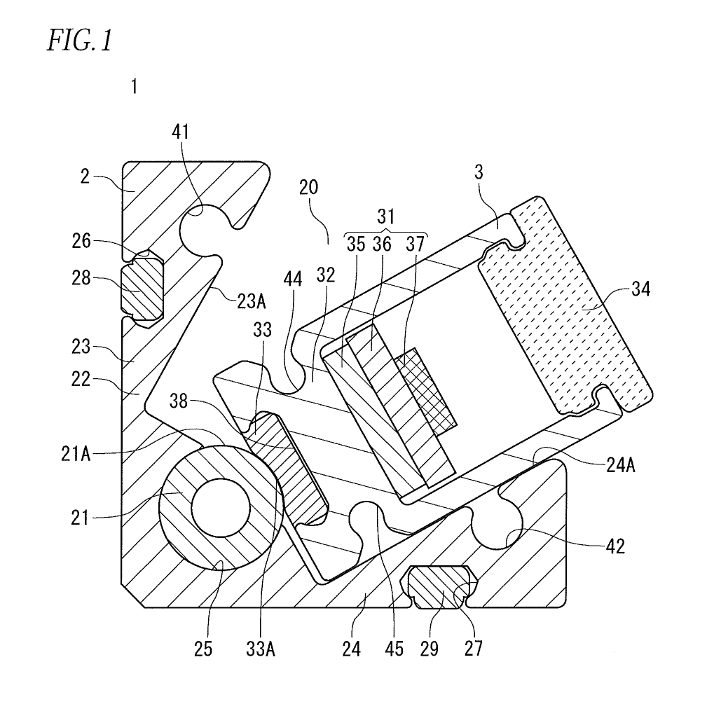

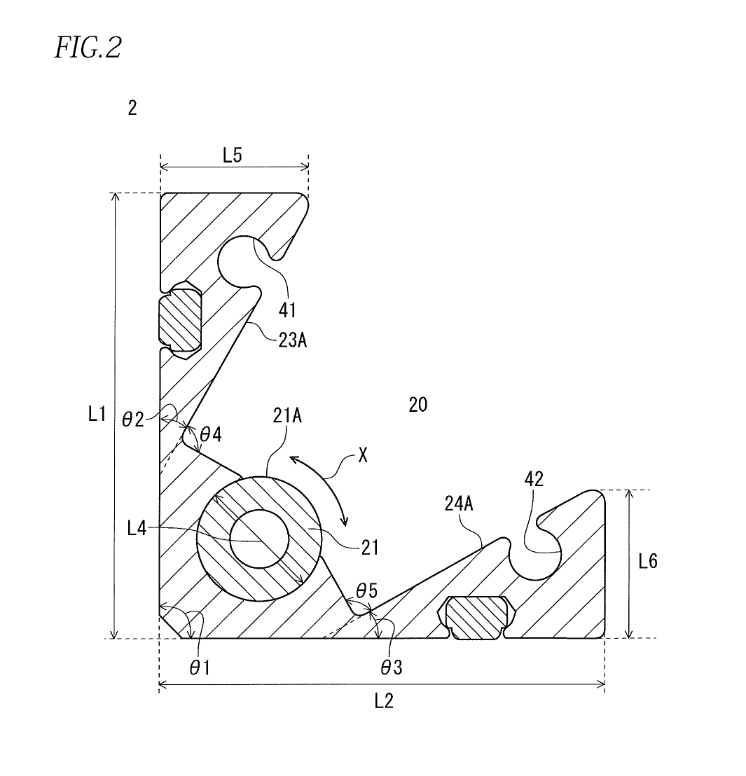

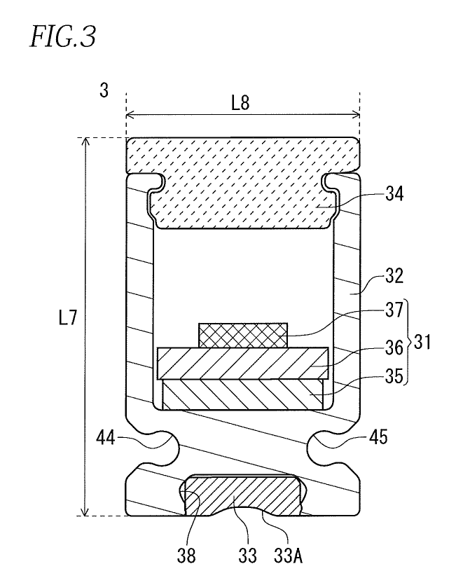

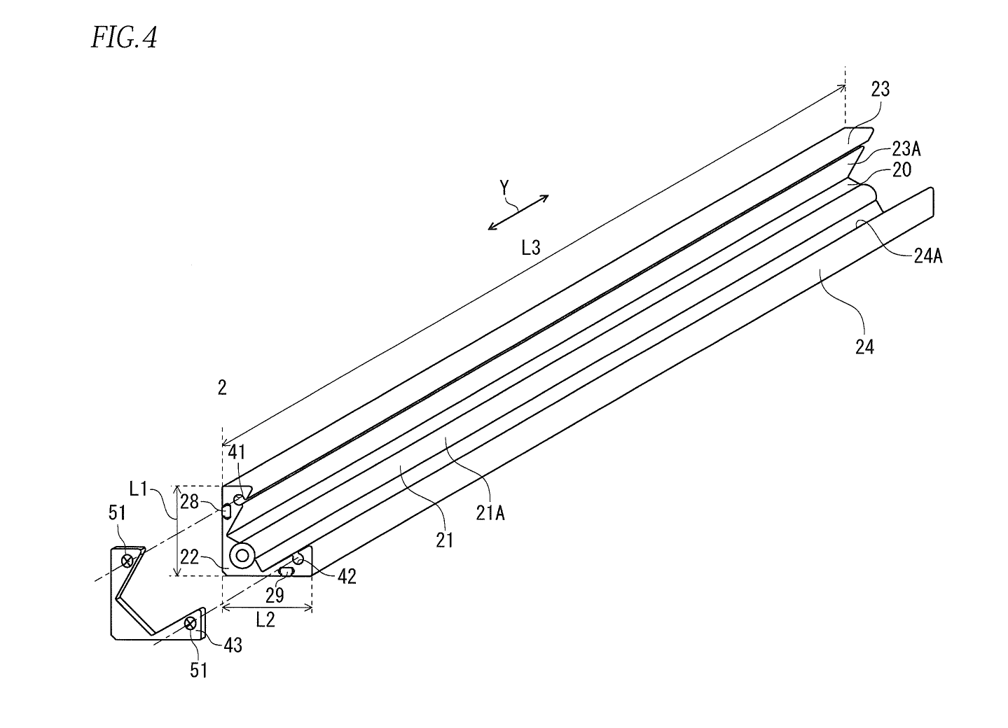

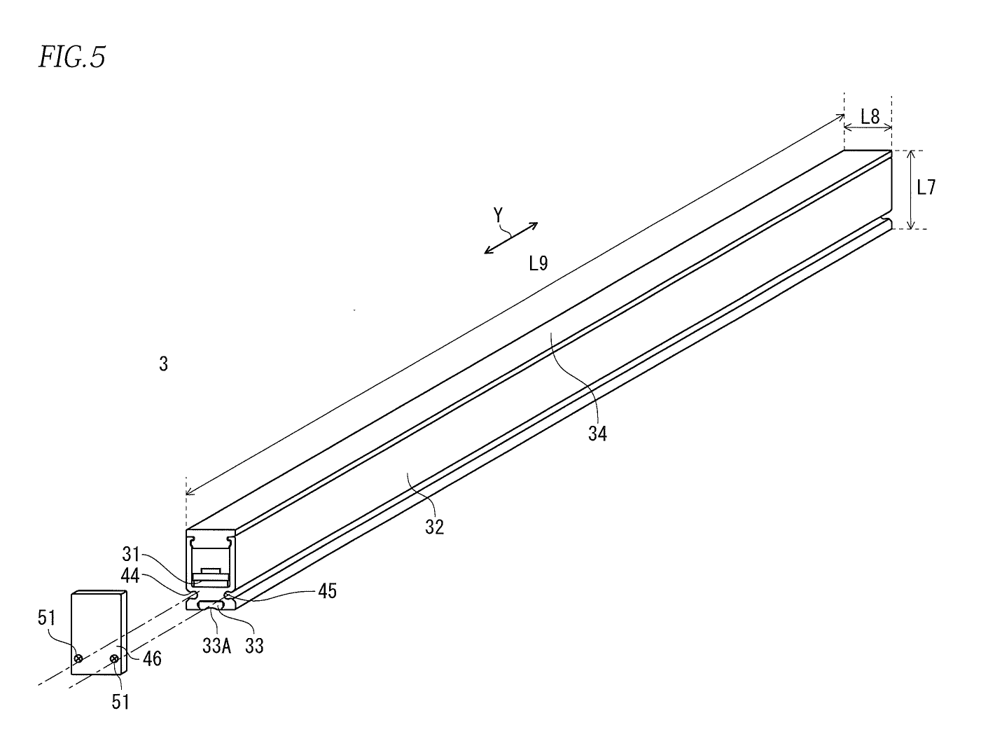

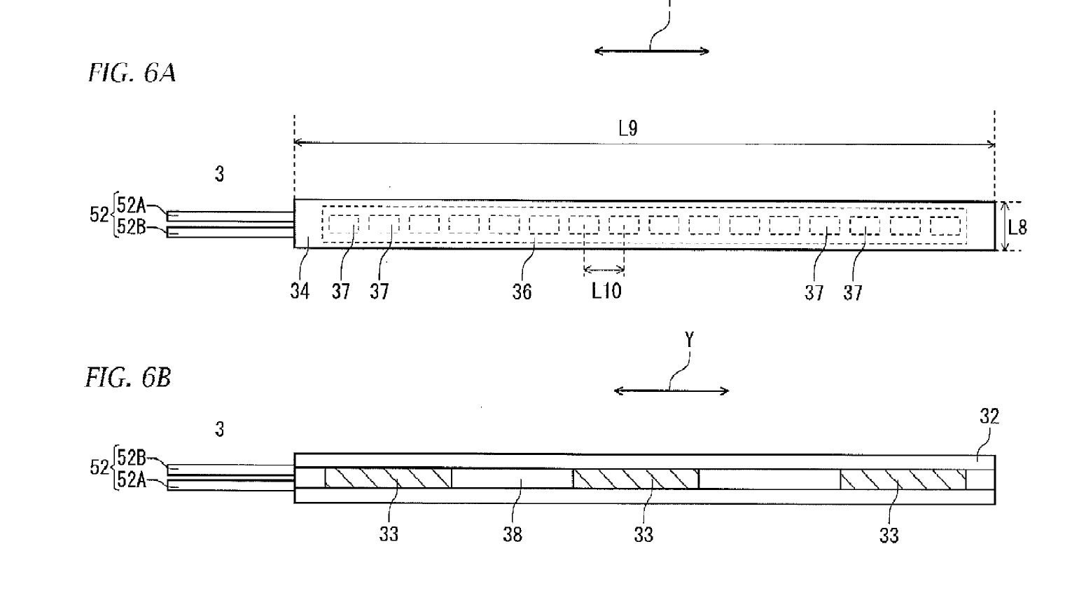

Hereinafter, embodiments of the present invention will be described. FIG. 1 is a side sectional view showing the configuration of a lighting apparatus in the first embodiment of the present invention. FIG. 2 is a side sectional view showing the configuration of a fixation unit of the lighting apparatus shown in FIG. 1. FIG. 3 is a side sectional view showing the configuration of a lighting unit of the lighting apparatus shown in FIG. 1. FIG. 4 is a perspective view showing the configuration of the fixation unit of the lighting apparatus shown in FIG. 1. FIG. 5 is a perspective view showing the configuration of the lighting unit of the lighting apparatus shown in FIG. 1. FIGS. 6A and 6B are a top view and a bottom view showing the configuration of the lighting unit of the lighting apparatus shown in FIG. 1.

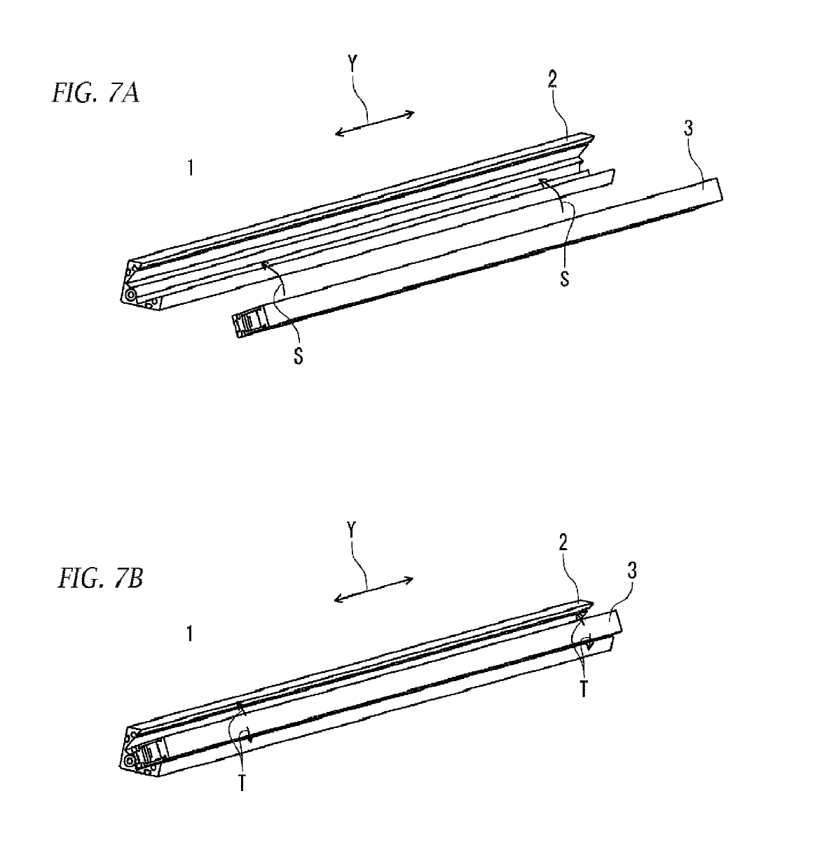

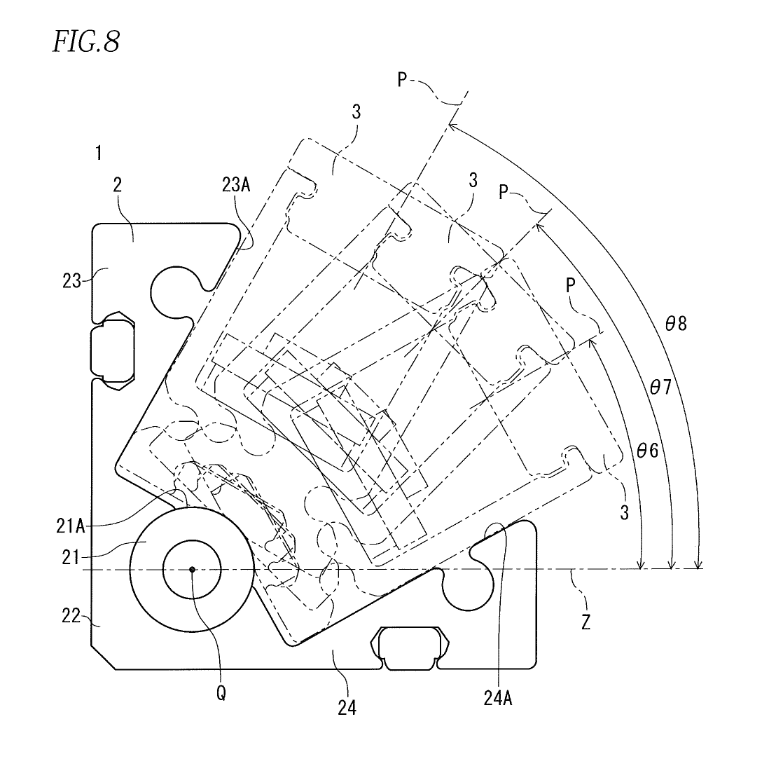

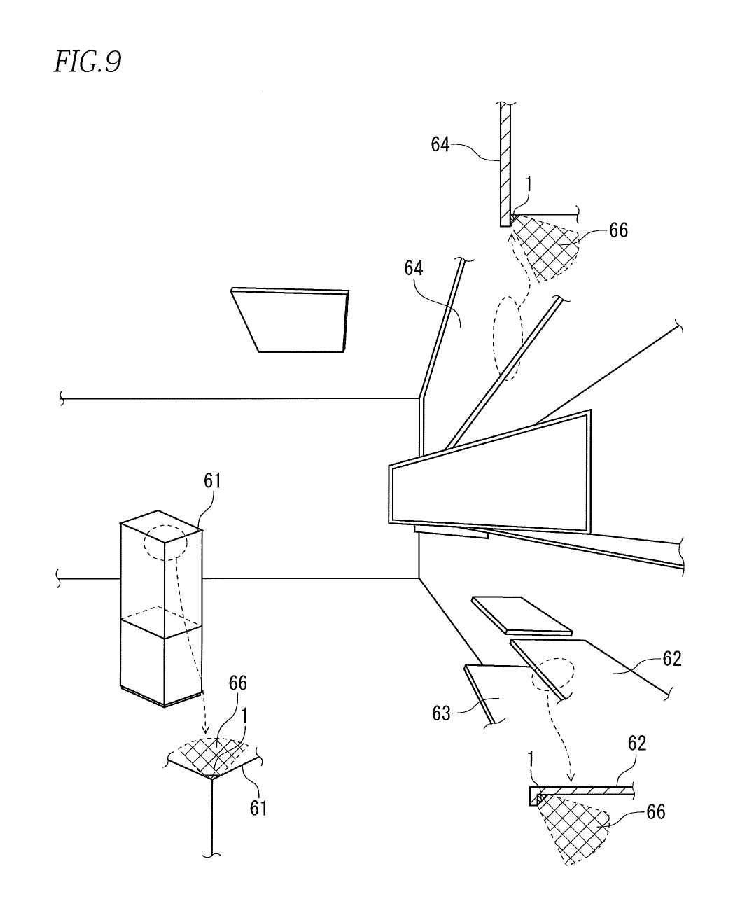

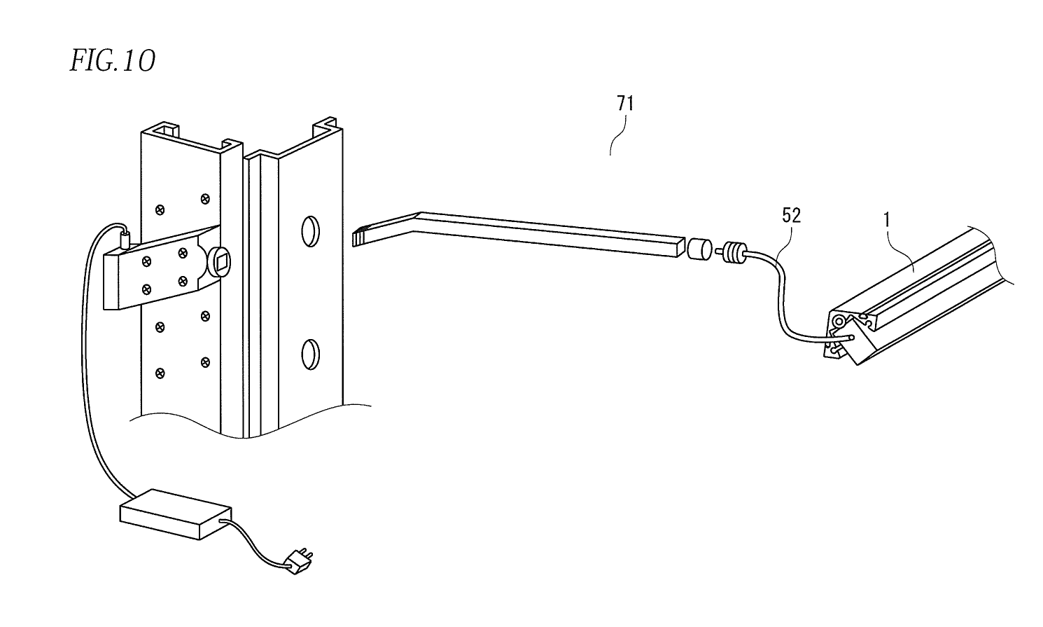

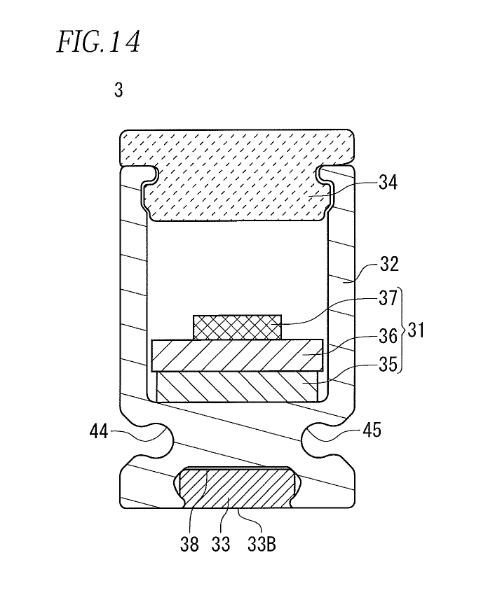

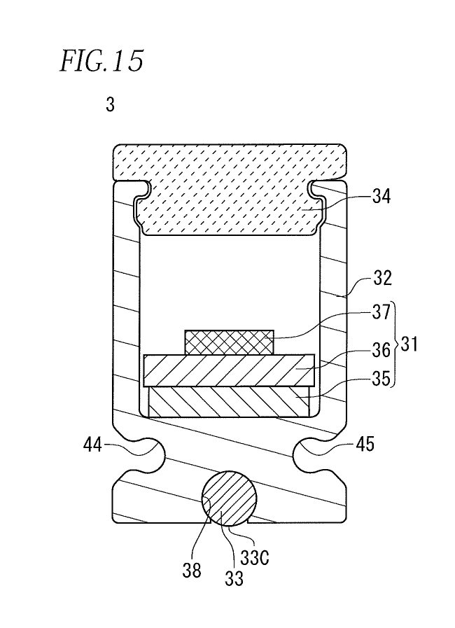

FIGS. 7A and 7B are perspective views showing the fixation unit and the lighting unit of the lighting apparatus shown in FIG. 1, when combined. FIG. 8 is a side view showing movement of the lighting unit in the fixation unit of the lighting apparatus shown in FIG. 1. FIG. 9 is a view showing locations where the lighting apparatus shown in FIG. 1 is installed. FIGS. 10 to 13 are views showing configurations for obtaining power, of the lighting apparatus shown in FIG. 1. FIG. 14 and FIG. 15 are sectional views showing other configurations of the lighting unit of the lighting apparatus in the first embodiment of the present invention.

As shown in the figures, a lighting apparatus 1 is composed of a fixation unit 2 and a lighting unit 3 attachable to and detachable from the fixation unit 2. First, the fixation unit 2 will be described. The fixation unit 2 is composed of a first mounting portion 21 and a fixation portion 22. The first mounting portion 21 is formed by a cylindrical member made of a magnetic material, along a longitudinal direction Y. The first mounting portion 21 is formed by a chromium-plated steel pipe, for example. Thus, the first mounting portion 21 has an arc surface 21A having an arc-shaped cross section perpendicular to the longitudinal direction Y and continuously formed along the longitudinal direction Y. The arc surface 21A is formed in a convex shape.

The fixation portion 22 is composed of a first fixation portion 23 and a second fixation portion 24 continuous from the first fixation portion 23. The first fixation portion 23 and the second fixation portion 24 are bent with an angle θ1 set at 90 degrees so as to be perpendicular to each other. The first mounting portion 21 is inserted and fixed in a grasp portion 25 formed at a continuous part between the first fixation portion 23 and the second fixation portion 24. Here, the size of the grasp portion 25 is slightly larger than the size of the cylindrical member of the first mounting portion 21. Therefore, the first mounting portion 21 can be inserted into the grasp portion 25 from one end side in the longitudinal direction Y. The fixation portion 22 is formed by extrusion of a nonmagnetic material such as aluminum, for example. In the fixation unit 2, the first mounting portion 21 of the cylindrical member is inserted from one end side in the longitudinal direction Y of the grasp portion 25 of the fixation portion 22, and the first mounting portion 21 is adhered and fixed to the grasp portion 25 by an adhesive agent.

The first fixation portion 23 and the second fixation portion 24 respectively have a first limiting surface 23A and a second limiting surface 24A for limiting the position at which the lighting unit 3 is magnetically attached to the fixation unit 2. The lighting unit 3 is placed in a region 20 surrounded by the first limiting surface 23A of the first fixation portion 23 and the second limiting surface 24A of the second fixation portion 24. The first fixation portion 23 and the second fixation portion 24 respectively have a first recess 26 and a second recess 27 on their outer sides. A first magnet portion 28 and a second magnet portion 29 are respectively held in the first recess 26 and the second recess 27.

The first fixation portion 23 and the second fixation portion 24 respectively have a first screw hole 41 and a second screw hole 42 for screw fastening, formed in the first limiting surface 23A and the second limiting surface 24A and extending along the longitudinal direction Y. The first screw hole 41 and the second screw hole 42 are used for, at both ends in the longitudinal direction Y of the fixation unit 2, fixing a pair of first end plates 43 for covering both ends of the fixation unit 2, with screws (see FIG. 4). In FIG. 4, only the first end plate 43 on one end side of the fixation unit 2 is shown. In other figures, the first end plates 43 are not shown as appropriate. The corners of the fixation unit 2 are rounded.

Next, the lighting unit 3 will be described. The lighting unit 3 is composed of a light source portion 31, a holding portion 32, and a second mounting portion 33. The holding portion 32 holds the light source portion 31. The light source portion 31 is held along the longitudinal direction Y of the holding portion 32. On the holding portion 32, a protection portion 34 having a light-transmitting property is provided on the light emission side of the light source portion 31. The holding portion 32 is formed by extrusion of a nonmagnetic material such as aluminum, for example. The protection portion 34 is formed of a plastic material, for example.

The light source portion 31 is composed of a wiring board 35, a printed wiring conductor 36, and an LED element 37 stacked from a side contacting the holding portion 32. As shown in FIG. 6A, a plurality of LED elements 37 are arranged along the longitudinal direction Y on the printed wiring conductor 36. The second mounting portion 33 is provided along the longitudinal direction Y, on a side where the light source portion 31 of the holding portion 32 is not blocked. The second mounting portion 33 has a mounting surface 33A to be magnetically attached at any position in a circumferential direction X on the arc surface 21A of the first mounting portion 21. The mounting surface 33A is a concave arc surface to be in surface-contact with the arc surface 21A of the first mounting portion 21 (see, particularly, the mounting surface 33A in FIG. 3). The second mounting portion 33 is formed of a magnet such as neodymium magnet.

As shown in FIG. 6(B), a plurality of second mounting portions 33 are provided with spaces therebetween along the longitudinal direction Y. The second mounting portions 33 may be formed of one member extending over the entire length in the longitudinal direction Y. In the case of forming the second mounting portion 33 by an expensive magnet, the second mounting portion 33 is configured in consideration of the cost and so as to be magnetically attachable. The holding portion 32 has a third screw hole 44 and a fourth screw hole 45 for screw fastening, extending along the longitudinal direction Y. The third screw hole 44 and the fourth screw hole 45 are used for, at both ends in the longitudinal direction Y of the lighting unit 3, fixing a pair of second end plates 46 for covering both ends of the lighting unit 3, with screws 51 (see FIG. 5). In FIG. 5, only the second end plate 46 on one end side of the lighting unit 3 is shown. In other figures, the second end plate 46 is not shown as appropriate.

As shown in FIGS. 6A and 6B, in the lighting unit 3, plus and minus power lines 52A and 52B are led out from the printed wiring conductor 36, for obtaining power from the outside. In other figures, the power lines 52A and 52B are not shown. The power lines 52A and 52B are formed as a power cord 52 (see FIGS. 10 to 13) for supplying power from the outside, on one side of the second end plate 46. The supply of power from the outside to the lighting apparatus 1 of the present invention will be described later. The corners of the lighting unit 3 are rounded.

In the lighting apparatus 1 configured as described above, the lighting unit 3 is inserted into the region 20 of the fixation unit 2 in the direction indicated by arrows S from the state shown in FIG. 7A, for example. Then, as shown in the state in FIG. 7B, the lighting unit 3 is attached to the fixation unit 2. Then, as shown in FIG. 7B, in the state in which the lighting unit 3 is magnetically attached to the fixation unit 2, the mounting surface 33A of the second mounting portion 33 of the lighting unit 3 is moved on the arc surface 21A of the first mounting portion 21 of the fixation unit 2 as indicated by arrows T.

Thus, as shown in FIG. 8, the angle at which the lighting unit 3 lights can be changed to θ6 to θ8. The angles θ6 to θ8 are angles from an extension line Z horizontally extending from a center point Q of the first mounting portion 21, to a center line P of the lighting unit 3. In FIG. 8, the angle θ6 is 30 degrees, the angle θ7 is 45 degrees, and the angle θ8 is 60 degrees.

The angles θ6 to θ8 are angles at which both wall surfaces of the holding portion 32 of the lighting unit 3 are limited by the first limiting surface 23A and the second limiting surface 24A of the fixation unit 2. Therefore, the angle at which both wall surfaces are limited by the first limiting surface 23A and the second limiting surface 24A is not limited to the above angles, but can be changed as appropriate. Since movement of the lighting unit 3 is limited by the first limiting surface 23A and the second limiting surface 24A of the fixation unit 2, the lighting unit 3 is prevented from moving more than necessary and being dropped off the fixation unit 2.

The lighting apparatus 1 of the present invention is assumed to be used as a light in display of products. Therefore, the lighting apparatus 1 of the present invention is required to be installed to furniture or a structure (frame body) so as not to be conspicuous in display of products, and required to irradiate the products with light. Here, the size of the lighting apparatus 1 of the present invention used for such a purpose will be described with actual examples. However, the size of the lighting apparatus 1 of the present invention is not limited to those described.

As shown in FIG. 2, a length L1 of the fixation unit 2 is 15 mm, and a length L2 thereof is 15 mm. As shown in FIG. 4, a length L3 in the longitudinal direction Y of the fixation unit 2 is set to a required length in accordance with a range in which lighting is needed, and for example, may be set at about 1000 mm. The first mounting portion 21 is formed with a length L4 of its diameter set to 4 mm. The first limiting surface 23A and the second limiting surface 24A of the first fixation portion 23 and the second fixation portion 24 are formed with angles θ2 and θ3 set to 30 degrees. Lengths L5 and L6 at the maximum thickness portions of the first fixation portion 23 and the second fixation portion 24 are 5 mm. Angles θ4 and θ5 of the first limiting surface 23A and the second limiting surface 24A of the fixation unit 2 with respect to the grasp portion 25 are 90 degrees.

Next, regarding the lighting unit 3, as shown in FIG. 3, a length L7 of the holding portion 32 is 13 mm, and a length L8 thereof is 8 mm. As shown in FIG. 5, a length L9 in the longitudinal direction Y of the lighting unit 3 is set to a required length in accordance with a range in which lighting is needed, and is set to be equal to or shorter than the length L3 of the fixation unit 2. The LED elements 37 of the light source portion 31 are arranged with a length L10 of the interval set to 7 mm along the longitudinal direction Y, as shown in FIG. 6A.

The lighting apparatus 1 formed in the size as described above is installed on furniture or a structure (frame body) as shown in FIG. 9, for example. When installed to a display frame 61, the lighting apparatus 1 irradiates a product or the like placed in the display frame 61, with light 66. When installed at the bottom of the shelf board 62, the lighting apparatus 1 emits light 66 downward of the shelf board 62, to perform indirect lighting or irradiate a product or the like on a shelf board 63 under the shelf board 62, with light 66. When installed at a lower portion of a wall surface 64, the lighting apparatus 1 emits light 66 downward of the wall surface 64, to be used for indirect lighting.

Since the first magnet portion 28 and the second magnet portion 29 are respectively formed in the first fixation portion 23 and the second fixation portion 24, if furniture or a structure to which these portions are attached is made of a material that allows magnetic attachment, installation and detachment can be easily performed.

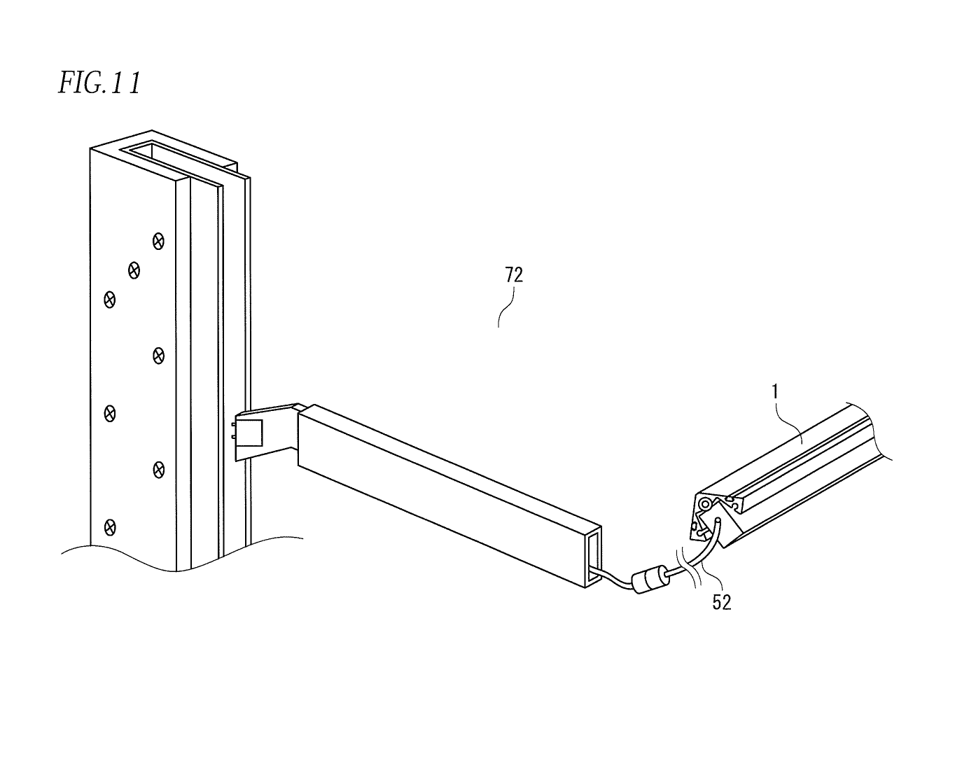

The configuration for the lighting apparatus 1 of the present invention to obtain power from the outside will be described. As shown in FIG. 10, for example, power for the lighting apparatus 1 may be obtained from an article support apparatus 71 which is installed to a wall surface and obtains power from the outside and which is similar to an article support apparatus disclosed in Japanese Laid-Open Patent Publication No. 2012-249721. As shown in FIG. 11, power for the lighting apparatus 1 may be obtained from a support apparatus 72 which is installed to a wall surface and obtains power from the outside and for which the applicant has filed an application (International Patent Application No. PCT/JP2014/82477).

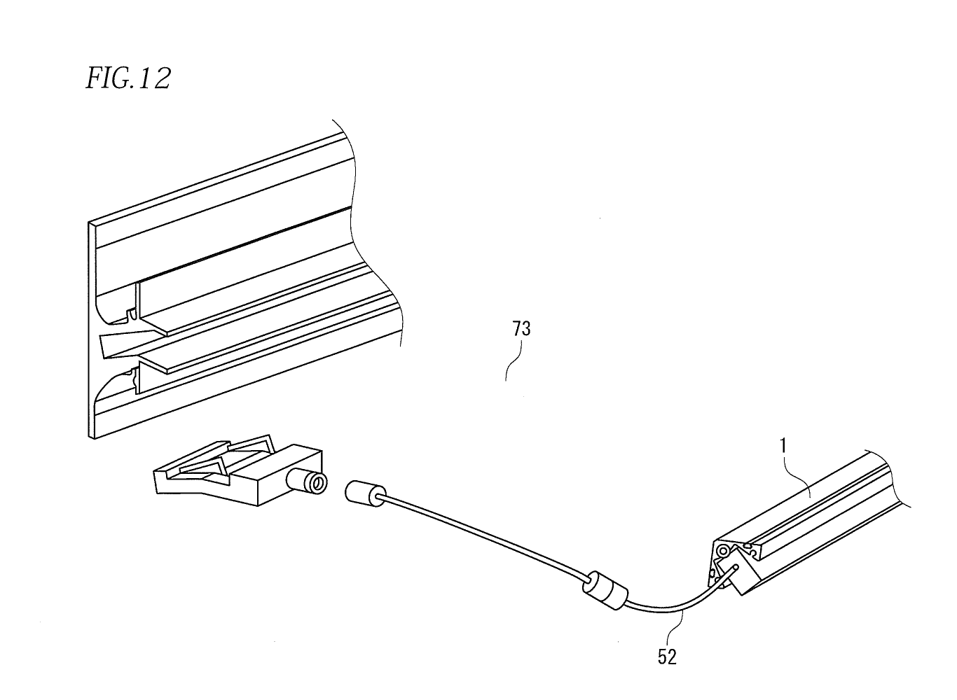

As shown in FIG. 12, power for the lighting apparatus 1 may be obtained from a support apparatus 73 which is installed to a wall surface and obtains power from the outside and which is a product dealt in by the applicant ([online], [searched on Jun. 16, 2015], the Internet <URL; http://www.onebyone.ne.jp/products/details.php?pr_id=379, http://www.onebyone.ne.jp/products/details.php?pr_id=383, http://www.onebyone.ne.jp/products/details.php?pr_id=387>).

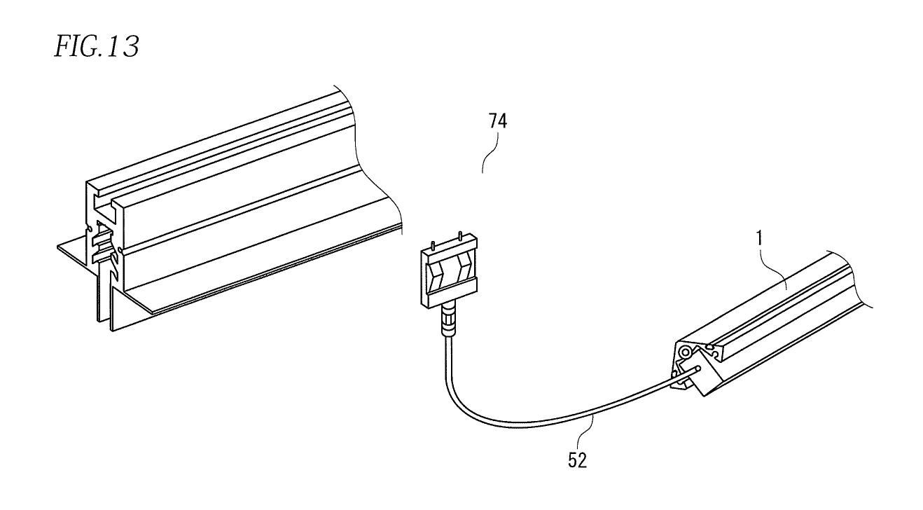

As shown in FIG. 13, power for the lighting apparatus 1 may be obtained from a support apparatus 74 which is installed to a ceiling and obtains power from the outside and for which the applicant has filed an application (Japanese Patent Application No. 2014-172161). The configuration for obtaining power in the present invention is not limited to the configurations described above. Any configuration may be used as long as power for the lighting apparatus 1 can be obtained. However, the configurations described above allow power for the lighting apparatus 1 to be obtained without influencing display of a product, or the like.

In the lighting apparatus of the first embodiment configured as described above, on the first mounting portion having the arc surface having an arc-shaped cross section perpendicular to the longitudinal direction of the fixation unit, the second mounting portion having the mounting surface to be magnetically attached, of the lighting unit can be attached and detached at any position in the circumferential direction on the arc surface of the first mounting portion. Therefore, a wide range can be irradiated with light, and the light irradiation angle can be easily changed.

Since the mounting surface of the second mounting portion is a concave arc surface to be in surface-contact with the convex arc surface of the first mounting portion, reliable magnetic attachment can be made, and the direction of light irradiation from the lighting unit to a desired part can be reliably changed.

Since the first mounting portion is formed by a cylindrical member made of a magnetic material and the second mounting portion is formed by a magnet, the structure can be simplified and the cost can be reduced.

Since a plurality of second mounting portions are formed along the longitudinal direction, the effect of the present invention can be obtained with low cost.

Since the lighting unit is placed in the region surrounded by the first limiting surface of the first fixation portion and the second limiting surface of the second fixation portion of the fixation unit, the lighting unit can be prevented from moving more than necessary.

Since the first fixation portion and the second fixation portion are bent so as to be perpendicular to each other, installation to a corner portion is facilitated.

Owing to the first magnet portion and the second magnet portion of the first fixation portion and the second fixation portion, the lighting apparatus can be installed to furniture or a structure (frame body) by magnetic force, and thus installation can be easily performed.

Means for attaching the first fixation portion and the second fixation portion of the lighting apparatus to furniture or a structure (frame body) is not limited to the first magnet portion and the second magnet portion. Screw holes may be formed in the first fixation portion and the second fixation portion, and they may be fixed to furniture or a structure (frame body) with screws penetrating the screw holes. In this configuration, the first magnet portion and the second magnet portion are not needed, and the lighting apparatus can be provided with low cost. In addition, the lighting apparatus can be installed even in the case where the furniture or the structure (frame body) is formed of a nonmagnetic material such as wood.

Since the light source portion is composed of LED elements, energy saving and size reduction are facilitated.

In the first embodiment, an example in which the second mounting portion 33 is formed by a magnet has been shown. However, without limitation thereto, at least one of the first mounting portion 21 and the second mounting portion 33 may be formed by a magnet so that the fixation unit 2 and the lighting unit 3 can be magnetically attached and detached with respect to each other.

In the above example, the arc surface 21A of the first mounting portion 21 has a convex shape and the mounting surface 33A of the second mounting portion 33 is a concave arc surface, and the arc surface 21A of the first mounting portion 21 and the mounting surface 33A of the second mounting portion 33 are brought into surface-contact with each other. However, without limitation thereto, for example, as shown in FIG. 14, the second mounting portion 33 may have a mounting surface 33B that is a flat surface, or as shown in FIG. 15, the second mounting portion 33 may have a mounting surface 33C formed by a cylindrical member having a convex arc surface.

In such a case, although the area where the arc surface 21A of the first mounting portion 21 is contact with the mounting surface 33B or the mounting surface 33C of the second mounting portion 33 is smaller than that in the first embodiment, the same usage as in the first embodiment is allowed by using a magnet having a great magnetic force or reducing the weight of the lighting unit 3 itself.

In the above example, the first mounting portion 21 is formed by a cylindrical member to form the arc surface 21A of the first mounting portion 21. However, without limitation thereto, for example, a semicylindrical member or a member corresponding to a partial arc of a cylinder may be used to form the arc surface 21A of the first mounting portion 21, whereby the same usage as in the first embodiment is allowed.

In the first embodiment, an example in which the fixation unit 2 and the lighting unit 3 have the same length in the longitudinal direction Y has been shown. However, without limitation thereto, in the case where the length in the longitudinal direction Y of the fixation unit 2 is greater than the length in the longitudinal direction Y of the lighting unit 3, the lighting unit 3 can be moved in the longitudinal direction Y of the fixation unit 2 when attached or detached. In addition, two lighting units 3 can be arranged in the longitudinal direction Y of the fixation unit 2. In this case, the power cords 52 for supplying power are provided on different sides in the longitudinal direction Y of the lighting units 3.

### Second Embodiment

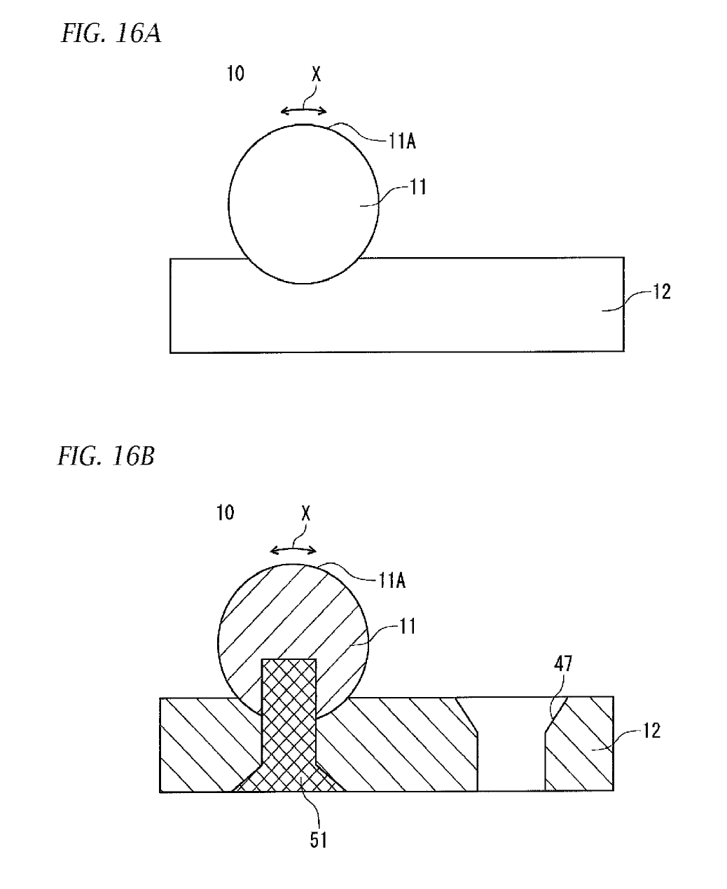

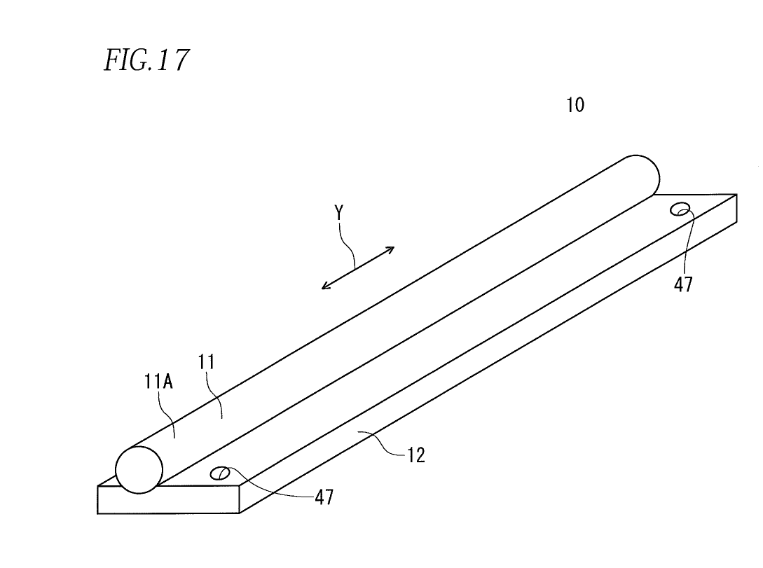

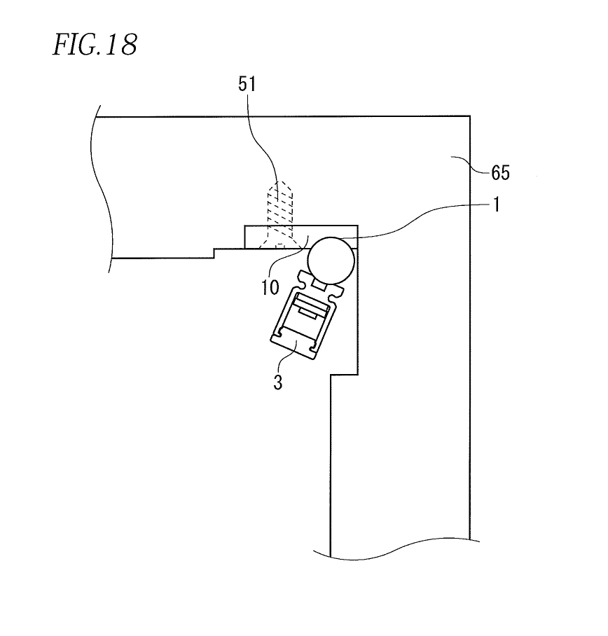

FIGS. 16A and 16B are a side view and a side sectional view showing the configuration of a fixation unit of a lighting apparatus in the second embodiment of the present invention. FIG. 17 is a perspective view showing the configuration of the fixation unit of the lighting apparatus shown in FIG. 16. FIG. 18 is a view showing an installation example of the fixation unit of the lighting apparatus shown in FIG. 16. In the figures, the same components as in the first embodiment are denoted by the same reference characters, and the description thereof is omitted. The configuration in the second embodiment has only a minimal function unlike that in the first embodiment. However, the configuration of the lighting unit 3 is the same as in the first embodiment, and therefore the description thereof is omitted as appropriate.

As shown in the figures, a fixation unit 10 includes: a first mounting portion 11 having an arc surface 11A having an arc-shaped cross section perpendicular to the longitudinal direction Y such that the arc shape is continuously formed along the longitudinal direction Y; and a fixation portion 12 to which the first mounting portion 11 is fixed. The fixation portion 12 is formed by a plate material, and has a fifth screw hole 47 formed therein. The first mounting portion 11 is formed by a columnar member, and is fixed to the fixation portion 12 by a screw 51. The mounting surface 33A of the second mounting portion 33 of the lighting unit 3 is magnetically attached at any position in the circumferential direction X on the arc surface 11A of the first mounting portion 11.

Next, the installation configuration of the lighting apparatus 1 of the second embodiment configured as described above will be described. First, the fixation unit 10 is fixed to a wall surface 65 with the screw 51 screwed into the fifth screw hole 47, for example. As in the first embodiment, the mounting surface 33A of the second mounting portion 33 of the lighting unit 3 is magnetically attached at any position in the circumferential direction X on the arc surface 11A of the first mounting portion 11 of the fixation unit 10.

In the lighting apparatus of the second embodiment configured as described above, in addition to the same effect as in the first embodiment, the configuration of the fixation unit is simplified, thus enabling the manufacturing with low cost.

It is noted that, within the scope of the present invention, the above embodiments may be freely combined with each other, or each of the above embodiments may be modified or abbreviated as appropriate.

Various modifications and alterations of this invention will be apparent to those skilled in the art without departing from the scope and spirit of this invention, and it should be understood that this is not limited to the illustrative embodiments set forth herein.

What is claimed is:

1. A lighting apparatus comprising:
a fixation unit; and
a lighting unit attachable to and detachable from the fixation unit, wherein
the fixation unit includes:
a first mounting portion having an arc surface whose cross section perpendicular to a longitudinal direction has an arc shape, the arc shape being continuously formed along the longitudinal direction; and
a fixation portion to which the first mounting portion is fixed,
the lighting unit includes:
a light source portion formed along the longitudinal direction;
a holding portion holding the light source portion; and
a second mounting portion provided along the longitudinal direction on the holding portion and having a mounting surface to be magnetically attached at any position in a circumferential direction on the arc surface of the first mounting portion, and
at least one of the first mounting portion and the second mounting portion is formed by a magnet.

2. The lighting apparatus according to claim 1, wherein
the arc surface of the first mounting portion has a convex shape, and
the mounting surface of the second mounting portion is a concave arc surface to be in surface-contact with the arc surface of the first mounting portion.

3. The lighting apparatus according to claim 2, wherein
the first mounting portion is formed by a cylindrical member made of a magnetic material, and
the second mounting portion is formed by a magnet.

4. The lighting apparatus according to claim 3, wherein
a plurality of the second mounting portions are formed along the longitudinal direction.

5. A lighting apparatus comprising:
a fixation unit; and
a lighting unit attachable to and detachable from the fixation unit, wherein
the fixation unit includes:
a first mounting portion having an arc surface whose cross section perpendicular to a longitudinal direction has an arc shape, the arc shape being continuously formed along the longitudinal direction; and
a fixation portion to which the first mounting portion is fixed,
the lighting unit includes:
a light source portion formed along the longitudinal direction;
a holding portion holding the light source portion; and
a second mounting portion provided along the longitudinal direction on the holding portion and having a mounting surface to be magnetically attached at any position in a circumferential direction on the arc surface of the first mounting portion,
at least one of the first mounting portion and the second mounting portion is formed by a magnet,
the fixation portion of the fixation unit includes a first fixation portion and a second fixation portion formed continuously from the first fixation portion,
the first mounting portion is fixed at a continuous part between the first fixation portion and the second fixation portion,
the first fixation portion and the second fixation portion have a first limiting surface and a second limiting surface for limiting a position at which the lighting unit is magnetically attached to the fixation unit, and
the lighting unit is placed in a region surrounded by the first limiting surface of the first fixation portion and the second limiting surface of the second fixation portion.

6. The lighting apparatus according to claim 5, wherein
the arc surface of the first mounting portion has a convex shape, and
the mounting surface of the second mounting portion is a concave arc surface to be in surface-contact with the arc surface of the first mounting portion.

7. The lighting apparatus according to claim 6, wherein
the first mounting portion is formed by a cylindrical member made of a magnetic material, and
the second mounting portion is formed by a magnet.

8. The lighting apparatus according to claim 7, wherein
a plurality of the second mounting portions are formed along the longitudinal direction.

9. The lighting apparatus according to claim 8, wherein
the first fixation portion and the second fixation portion are bent so as to be perpendicular to each other.

10. The lighting apparatus according to claim 9, wherein
the first fixation portion and the second fixation portion respectively have a first magnet portion and a second magnet portion formed on sides opposite to the first limiting surface and the second limiting surface.

11. The lighting apparatus according to claim 10, wherein
the light source portion is composed of an LED.

12. The lighting apparatus according to claim 5, wherein
the first fixation portion and the second fixation portion are bent so as to be perpendicular to each other.

13. The lighting apparatus according to claim 1, wherein
the light source portion is composed of an LED.
